(19) United States
(12) Patent Application Publication
(10) Pub. No.: US 2026/0300478 A1
(43) Pub. Date: Oct. 1, 2026

(54) ARTIFICIAL INTELLIGENCE FOR CUSTOMIZED SECURITY SHIELD DEPLOYMENT

(71) Applicant: Microsoft Technology Licensing, LLC, Redmond, WA (US)

(72) Inventors: Ashish JAIN, Bellevue, WA (US); Sinead Christina O’DONOVAN, Seattle, WA (US)

(21) Appl. No.: 19/094,231

(22) Filed: Mar. 28, 2025

(51) Int. Cl. G06F 21/55

(52) U.S. Cl. CPC G06F 21/554; G06F 2221/034

(57) ABSTRACT

A method disclosed autonomously generates and deploys a customized security shield to protect specific network entities from an attack exploiting a security vulnerability. The method includes receiving description of a threat mitigation recommendation, identifying a security policy applicable to the threat mitigation recommendation, analyzing text of the threat mitigation recommendation to determine a value for at least one metadata field defined in the security policy, constructing a query to an enterprise security graph to identify entities stored in association with the value, populating a security rule template with entity identifiers obtained from the enterprise security graph in response to the query; and using the populated security rule template to deploy a customized security shield to protect the specific network entities from an attack exploiting the security vulnerability.

### BACKGROUND

A variety of publicly available language models can generate executable code based on natural-language descriptions of code functionality. These widely available generative artificial intelligence (AI) tools make it possible for individuals who lack coding knowledge to easily generate code, including malware. In the modern security space, new security vulnerabilities are discovered daily. Generative AI tools allow cyber criminals to exploit these new security vulnerabilities faster than ever before. This landscape has given rise to the term “zero-day vulnerability,” which refers to the typical time window between the discovery of a security vulnerability by a hardware or software vendor and the potential exploitation of that vulnerability by a nefarious party.

Even in scenarios where it is possible for security teams to develop software patches quickly, expedited roll-out is not always desirable due to the likelihood of unforeseen bugs and wide-scale consequences that may unfold if testing has been inadequate. Security teams widely recognize that it is neither practicable nor desirable to implement patching solutions with rapid (e.g., same-day) response times.

### SUMMARY

According to one implementation, a method for autonomously generating and deploying a customized security shield includesreceiving a description of a threat mitigation recommendation referencing a security vulnerability and identifying a security policy applicable to the threat mitigation recommendation. The security policy identifies a set of metadata fields and a security rule template containing placeholders for entities referenced in an enterprise security graph. The method further provides for analyzing the threat mitigation recommendation to determine a value for at least one metadata field of the set of metadata fields defined in the security policy, constructing a query to the enterprise security graph to identify specific network entities stored in association with the value for the at least one metadata field; populating the security rule template with entity identifiers obtained from the enterprise security graph in response to the query; and based at least in part on the population of the security rule template, deploying a customized security shield to protect the specific network entities from an attack exploiting the security vulnerability.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates an example system that autonomously develops and deploys customized security shields within a network to proactively thwart cyberattacks designed to exploit newly discovered security vulnerabilities.

FIG. 2A illustrates aspects of another example system that autonomously develops and deploys customized security shields within a network.

FIG. 2B illustrates further aspects of the system described and shown with respect to FIG. 2A.

FIG. 3 illustrates example operations for autonomously generating and deploying a customized security shield that temporarily patches a known security vulnerability

FIG. 4 illustrates an example computing device for use in implementing the described technology.

### DETAILED DESCRIPTION

The herein-disclosed technology facilitates AI-automated development and deployment of customized security rules and policies– referred to herein as “customized security shields” - that increase protections against cyberattacks designed to exploit zero-day vulnerabilities. A customized security shield includes an executable component, such as a targeted network quarantine or segmentation rule (e.g., traffic filtering rule, firewall rule, access control rule) that is crafted in response to the discovery of a new security vulnerability to prevent potential exploitation of that vulnerability. Although there is no definite enforcement period defined in relation to each customized security shield, these shields are intended to complement rather than replace existing patch development and deployment cycles by decreasing security risks incurred throughout the time period that is needed to develop, test, and roll out a permanent patching solution to each newly discovered vulnerability. The herein-disclosed customized security shields can be rolled out rapidly within an enterprise network – e.g., within minutes of discovering a new vulnerability. This offers a security advantage over traditional software patch development cycles that take much longer (days or weeks) to roll out.

Although there exist other security technologies that autonomously create and enforce security rules, most are designed to react to detected threats as opposed to providing preemptive and preventative protection. For example, some AI-driven security technologies look for patterns of activity indicative of an in-progress cyberattack (e.g., suspicious sign-ons, suspicious grants of privileges, lateral data movements) and deploy protections in response. However, these cyber-attack detection mechanisms are implemented after a threat has infiltrated a network, meaning that some damage is often incurred before the cyberattack can be stopped. In these scenarios, the aftermath of a cyberattack can often leave a security team with clean-up work, such as updating devices to clear malware and data theft remediation measures.

In contrast to these existing reactionary cyber-attack detection mechanisms, the herein-disclosed technology provides an intelligence-backed proactive approach that autonomously generates and deploys security protections to prevent exploitation of newly discovered network vulnerabilities before there is any evidence that those vulnerabilities have been exploited. This, in turn, reduces the workload of security teams (e.g., by eliminating threat mitigation and clean-up work) while extending the timeframe allotted to security teams to develop and deploy security patches in a controlled, responsible manner.

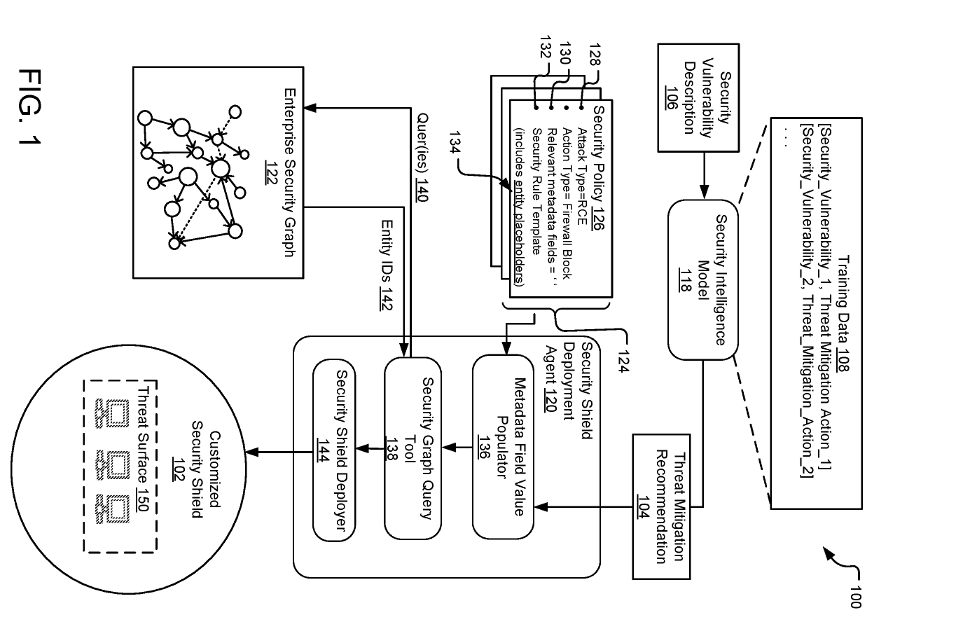

FIG. 1 illustrates an example system 100 that autonomously develops and deploys customized security shields (e.g., a customized security shield 102) within a network to proactively thwart cyberattacks designed to exploit newly discovered security vulnerabilities. Each instance of the customized security shield 102 includes one or more executable security rules enforceable by device(s) within the network to prevent exploitation of a specific security vulnerability. In implementations, it is possible to develop and deploy the customized security shield 102 on the same day the security vulnerability is discovered, such as within minutes or hours of the publication of an initial security bulletin identifying the security vulnerability.

The system 100 includes two complimentary components, including a security intelligence model 118 and a security shield deployment agent 120, both of which comprise executable software. The security intelligence model 118 executes operations for processing descriptions of newly discovered security vulnerabilities and, based on the description processing, generates and outputs generalized threat mitigation recommendations (e.g., a threat mitigation recommendation 104). The security shield deployment agent 120 receives the generalized threat mitigation recommendations and performs actions that translate the generalized threat mitigation recommendations to specific security rules and policies uniquely tailored for execution within a security network with a known physical architecture. Stated differently, the security shield deployment agent 120 transforms a generalized threat mitigation recommendation into a network-customized executable rule or policy that, when executed, implements the generalized threat mitigation recommendation.

The security intelligence model 118 is a language model trained to analyze textual inputs and may, for example, be a natural language processing (NLP) model or a multimodal model that can receive prompts that include various types of input (e.g., text, image, audio, and/or video data) and likewise generate outputs of multiple types that are not necessarily the same as the input type. Further examples of language models include transformer-based models such as generative pre-trained transformer (GPT) models, Open Pretrained Transformer (OPT) models, and Bidirectional Encoder Representations from Transformers (BERT) models, as well as Bioscience Large Open-science Open-access Multilingual (BLOOM) models, seq2seq models, long short-term memory (LSTM) network, and recurrent neural networks (RNNs). Examples of publicly available multimodal language models include the Mistral AI model and the large language model Meta AI (LLaMa) model.

In one implementation, the security intelligence model 118 is trained on a corpus of training data 108 that includes thousands of descriptions of security vulnerabilities paired with corresponding threat mitigation actions identified as appropriate measures that prevent exploitation of each one of the security vulnerabilities. An example description of a security vulnerability description is a security bulletin released by a cloud service provider. For example, it is common for a large software company to release security bulletins that describe newly discovered software and hardware vulnerabilities. In some cases, these bulletins may include general descriptions of workarounds or links to updates that can be executed to address vulnerabilities; however, it is not always practical or possible to deploy the workarounds or updates on enterprise machines as quickly as it is desired to implement protections. For example, some security vulnerabilities may impact thousands of machines across different sectors of a company, in which case it may be necessary for technical administrators to schedule time to work on each of the thousands of machines.

During the training of the security intelligence model 118 conducted using the training data 108, the security intelligence model 118 learns semantic associations between security vulnerabilities and corresponding, appropriate threat mitigation actions.

In one implementation, the security intelligence model 118 includes a generative language model that is trained on the above-described inputs (security vulnerabilities paired with threat mitigation actions) and that, once trained, is capable of processing descriptions of newly discovered security vulnerabilities and generating corresponding threat mitigation recommendations. As input, the security intelligence model 118 receives and processes a security vulnerability description 106 that identifies a potential security vulnerability. As used herein, a "potential security vulnerability" refers to a weakness or flaw in a system, software, or network that could be exploited by an attacker to gain unauthorized access, cause damage, or compromise the system's integrity. While it may not have been actively exploited yet, the vulnerability presents a risk because, under the right circumstances, it could be used to breach security or disrupt operations.

Based on processing of the security vulnerability description 106, the security intelligence model 118 generates a threat mitigation recommendation 104. The threat mitigation recommendation 104 is a recommendation that identifies a generalized response action that may be taken to prevent exploitation of the security vulnerability identified in the security vulnerability description 106.

In another implementation, the security intelligence model 118 includes a non-generative back-end intelligence component that ingests security updates and works in latent space, learning newly discovered security vulnerabilities paired with threat mitigation actions. In this implementation, a separate generative AI component (e.g., language model) is employed to access the intelligence component and utilize the learned intelligence to generate threat mitigation recommendations (e.g., a threat mitigation recommendation 104) upon request, such as in response to receiving a new security bulletin as input.

The generalized response action identified in the threat mitigation recommendation 104 is not specific to the network infrastructure of a particular enterprise and does not, for example, identify specific enterprise devices, identities, or metadata descriptors used to internally map enterprise entities or track interactions between identities and resources within an enterprise. Therefore, the threat mitigation recommendation 104 is not executable and cannot typically be implemented without further identification of specific entities, such as accounts, resources, or devices, that are vulnerable to potential attack. For example, implementation of the generalized response action may depend upon the identification of specific devices within a network that have attributes referenced in the threat mitigation recommendation 104 and/or upon the construction of rules unique to each different enterprise, such as rules that depend upon communication patterns usable to identify trusted and untrusted communication sources.

In some implementations, the security intelligence model 118 is deployed by a cloud-based service provider on behalf of one or multiple different enterprises. The outputs of the security intelligence model 118 are agnostic to the enterprise that is ultimately deploying the corresponding customized security shields.

By example, the security vulnerability description 106 may identify a version of an executable file that is vulnerable to a particular type of attack, such as a Remote Code Execution (RCE) attack that allows an individual to execute malicious code on a network machine, without having physical access to the machine. In this case, the threat mitigation recommendation 104 is a recommendation to temporarily block traffic from unknown sources that is routed to vulnerable versions of the executable.

By further example, the security vulnerability description 106 may describe a particular data packet pattern that, when present, disrupts packet authentication processes commonly performed by domain controllers. If exploited, this vulnerability could result in a denial of service (DoS) attack that renders domain controllers unresponsive and disrupts enterprise operations. In this example, the threat mitigation recommendation 104 is a recommendation to set up a filtering rule on a network proxy that inspects packets and blocks packets routed to domain controllers that also contain the data packet pattern.

In yet still another example, the security vulnerability description 106 identifies a security token that has been flagged as potentially compromised in a data breach. The security vulnerability description 106 indicates that the security token is usable to acquire access to email accounts across the enterprise. In this example, the threat mitigation recommendation 104 is a recommendation to implement a filtering rule that disallows the use of the token to access high-profile email accounts (e.g., for company executives) for all requests except those originating at known sources (e.g., trusted IPs).

Notably, some implementations of the disclosed technology do not include the security intelligence model 118. For example, a human administrator may manually review the security vulnerability description 106 and independently, or with assistance from other (non-AI) software tools, generate the threat mitigation recommendation 104 for input to the security shield deployment agent 120, as further described below.

The threat mitigation recommendation 104 received at the security shield deployment agent 120 includes a text-based description of a generalized action or set of actions that may be implemented to help address the corresponding security vulnerability (e.g., as described in the security vulnerability description 106). The security shield deployment agent 120 also receives some description of the security vulnerability. For example, the security vulnerability is explicitly identified and described within the threat mitigation recommendation 104, or else the security vulnerability description 106 is provided to the security shield deployment agent 120 as an additional input.

Upon receiving the threat mitigation recommendation 104, the security shield deployment agent 120 analyzes the threat mitigation recommendation 104 and/or the description of the corresponding security vulnerability and categorizes the threat mitigation recommendation 104, such as based on the type of action that is recommended (e.g., a blocking action, filtering action, packet inspection action) and/or based on a relevant cyberattack type classification 128 that is identified as being the most likely type of attack to exploit the corresponding security vulnerability. The security shield deployment agent 120 utilizes this categorization to select a relevant security policy (e.g., security policy 126) from an index of stored security policies 124 associated with different cyberattack types and/or action types. In one implementation, the different security policies 124 are specific to different cyberattack types.

In FIG. 1, the security policy 126 identifies a cyberattack type classification 128, which is, in this example, “RCE” (Remote Code execution). An RCE attack typically occurs when an attacker exploits a vulnerability that allows remote execution of code on a machine to which the attacker does not have physical access. Although not shown, it is assumed that the security vulnerability description 106 references “RCE” as the type of attack and further assumed that the threat mitigation recommendation 104 identifies an action to help thwart a remote code execution (RCE) attack. In this example, the security policy 126 has been selected due, at least in part, to the cyberattack type classification 128 matching the type of attack identified as relevant to the threat mitigation recommendation 104.

The security policy 126 is selected from a plurality of stored security policies that respectively reference different cyberattack type classifications and/or different action types (e.g., blocking action, filtering action). In another example, the cyberattack type classification 128 is “elevation of privilege (EoP),” which typically occurs when an attacker with limited access (such as a normal user account) exploits vulnerabilities or misconfigurations to escalate their privileges to an administrator or root level. Once the attacker acquires higher privileges, they can carry out actions that a regular user cannot, such as installing malware, accessing sensitive data, or modifying system configurations. In still another example, the cyberattack type classification 128 is a denial of service (DoS) attack, which aims to make a system, service, or network resource unavailable to its intended users, such as by overwhelming it with excessive traffic or requests. In still yet another example, the cyberattack type classification 128 is a Man-in-the-Middle (MitM) attack, in which an attacker intercepts and possibly alters communications between two parties without their knowledge. Still other cyberattack type classifications include phishing, SQL injection, cross-site scripting (XSS), ransomware, password attacks, and more.

In some cases, the threat mitigation recommendation 104 explicitly identifies the relevant cyberattack type. In other implementations where the cyberattack type is not explicitly identified in inputs provided to the security shield deployment agent 120, the security shield deployment agent 120 infers the cyberattack type based on a semantic assessment of the threat mitigation recommendation 104, such as by instructing a generative language model to analyze the threat mitigation recommendation 104 and infer the relevant cyberattack type.

Each one of the security policies 124 includes a security rule template 132 that contains entity placeholders 134 corresponding to entities (e.g., devices, services, accounts usernames) referenced in an enterprise security graph 122. The security rule template 132 is a document that partially defines a set of operations executable to create the customized security shield 102. These operations are said to be “partially defined” due to the fact that they respectively reference the entity placeholders 134, which are null (placeholder) fields that are to be populated prior to execution of the operations defined in the security rule template 132. At the time the security rule template 132 is initially accessed, the entity placeholders 134 represent and correspond to unknown values (“entity identifiers”). For example, security rule template 132 includes executable code with operators that target null placeholder fields. These operators depend upon population of the placeholder fields.

In one implementation, the logic within the security rule template 132 is in the form of code in a programming language. Once the entity placeholders 134 are populated with values as described further below, the code can be compiled to create a binary executable that, when executed, implements the customized security rule 102. In still another implementation, the logic within the security rule template 132 is in the form of a natural language instruction(s) that describes code functionality. In this implementation, the natural language references the entity placeholders 134. Once the entity placeholders 134 are populated with values, the natural language instruction(s) are passed to a language model. In response, the language model generates code that can be compiled and then executed to implement the customized security shield 102. In both of the implementations described above, the execution of the code that is within or generated based on the security rule template 132 is contingent upon a prior identification of values that correspond to each of the entity placeholders 134.

In addition to the security rule template 132, the security policy 126 also identifies a set of relevant metadata fields 130 that correspond, in some respect, to entity identifiers (defined below) that are used to populate the entity placeholders 134. As is described further below, the set of relevant metadata fields 130 is used to generate one or more queries to the enterprise security graph 122 that are executable to acquire the entity identifiers that are, in turn, used to populate the entity placeholders 134.

The metadata fields within the relevant set of metadata fields 130 correspond to like-named metadata fields defined within the enterprise security graph 122 (described below). The relevant set of metadata fields 130 are stored in the enterprise security graph 122 in association with graph nodes representing enterprise entities and/or graph edges that represent interactions between enterprise entities.

It is assumed that the enterprise security graph 122 (described below) is defined for a specific enterprise that is using the security shield deployment agent 120 to deploy customized security shield 102. In one implementation, the enterprise security graph 122 includes nodes that correspond to entity identifiers. The “entity identifiers” stored within the enterprise security graph 122 include the identities and resources of the enterprise. In this context, an identity represents an entity that can interact with resources or perform actions on resources. Examples of identities include devices (e.g., MAC addresses), applications (e.g., application identifiers), services (e.g., application programming interface (API) clients), and users (e.g., usernames, email addresses). In contrast, the term “resource” refers to an object, service, or data that can be accessed, modified, or interacted with by an identity. Examples of resources include files, databases, secrets (keys), cloud services (e.g., API endpoints), and storage accounts. In the security graph 122, relationships and communications between nodes (identities and resources) are shown as edges. For example, the security graph 122 includes at least some nodes corresponding to devices with communications between those nodes represented by edges. Both nodes and edges are stored with metadata. For example, a node corresponding to a device stores metadata indicating all processes installed on the device, what ports those processes are listening on, the protocols used and more. Likewise, the edges (communications between devices) include metadata that identifies the timestamp of each communication as well as the specific processes and ports involved in transmitting and receiving the communication.

Obtaining entity identifiers to populate the entity placeholders 134 within the security rule template 132 is a multi-step process. First, the security shield deployment agent 120 determines relevant metadata values that correspond to the relevant set of metadata fields 130. Then, the relevant metadata values are used to search the enterprise security graph 122 to obtain entity identifiers (values) to populate the entity placeholders 134.

The initial part of this process (metadata field value identification) is carried out by a metadata field value populator 136. The metadata field value populator 136 first retrieves the set of relevant metadata fields 130 from the security policy 126 and then parses the threat mitigation recommendation 104 to identify specific, referenced values that correspond to the relevant metadata fields 130. In one implementation, the metadata field value populator 136 includes a Named Entity Recognition (NER) model that is trained to classify entities – specifically, entities that correspond to metadata fields referenced in the enterprise security graph 122. For example, the NER model is trained to parse a document and determine whether each entity referenced by name is a member of learned classification and – more specifically, a value that corresponds to a specific metadata field identifiers referenced in the enterprise security graph 122.

Assume, for example, that the set of relevant metadata fields 130 includes metadata fields identifying a process (e.g., the metadata field is “ProcessName”) and a process version (e.g., the metadata field is “ProcessVersion”). Here, “ProcessName” stores an entity identifier that identifies a software component such as an application, operating system, driver, or patch, while “ProcessVersion” identifies a release version for the corresponding process. Further assume that the threat mitigation recommendation 104 describes a security vulnerability in version 24 of the Windows 11 operating system. In this case, the metadata field value populator 136 provides the NER model with instructions to identify values within the threat mitigation recommendation 104 that correspond to the metadata fields “ProcessName” and “ProcessVersion.” The NER model populates the metadata fields “ProcessName” and “ProcessVersion” by returning: “ProcessName=Windows11” and “ProcessVersion=24.”

After the metadata field value populator 136 has populated the relevant metadata fields 130 with corresponding relevant metadata values extracted from the threat mitigation recommendation 104, the security shield deployment agent 120 uses the relevant metadata values to search for and obtain identifiers to populate the entity placeholders 134 within the security rule template 132. At this step, the security graph query tool 138 is employed to construct one or more queries 140 to the enterprise security graph 122. The queries 140 are designed to extract graph identifier(s) that correspond to specific entities of the enterprise (e.g., devices, accounts, users) that are described or in some way characterized by the relevant metadata values identified with respect to the set of relevant metadata fields 130. For example, the security graph query tool 138 queries the enterprise security graph 122 to request all identifiers for all devices currently executing version 24 of the Windows 11 operating system.

In implementations, the queries 140 may be carried out as a single query or as a sequence of queries to obtain entity identifiers that correspond to different subsets of the relevant metadata fields 130. Although not shown in FIG. 1, the security policy 126 includes some information indicating how each of the relevant metadata fields 130 relates to corresponding one of the entity placeholders 134 within the security rule template 132. For example, the security policy 126 may include an instruction to obtain one of the entity placeholders 134 by querying the enterprise security graph 122 based on a first subset of the relevant metadata fields 130 and another instruction to obtain a different one of the entity placeholders 134 by querying the enterprise security graph 122 based on a second different subset of the relevant metadata fields 130.

The security graph query tool 138 executes the queries 140 (e.g., as either a single query or multiple queries) on the enterprise security graph 122 and, in response, acquires entity identifiers 142 corresponding to the entity placeholders 134 in the security rule template 132. In a typical implementation, at least some of the entity identifiers 142 returned in response to the query 140 identify a set of network devices that collectively serve as a threat surface 150 for the corresponding potential cyberattack – that is, physical network locations vulnerable to a cyberattack exploiting the security vulnerability.

In some implementations, the queries 140 may also or alternatively return identifiers and/or security graph metadata values that are useable to define a “threat signature” – e.g., characteristics of communications or network events that dictate when specific enforcement action(s) defined within the security rule template 132 are to be executed. For example, the entity identifiers 142 may, in some implementations, identify IP addresses that are trusted, known communicators with a set of identified devices that collectively comprise the threat surface 150. For example, the set of trusted IPs may be used to define an exemption for a firewall rule (e.g., “block all traffic to [X] set of destinations except for traffic arriving from [trustedIPs]).” Likewise, the security rule template 132 may, in some implementations, include a placeholder for a set of blacklisted (known malicious) IP addresses that is populated based on information in the threat mitigation recommendation 104 or within the enterprise security graph 122.

After the entity identifiers 142 are acquired from the enterprise security graph 122 per the quer(ies) 140, the security graph query tool 138 populates the entity placeholders 134 with the entity identifiers 142. A security shield deployer 144 then creates and deploys the customized security shield 102 based on the populated security rule template 132. In some implementations, the customized security shield 102 is created, at least in part, by executing code included within the security rule template 132 that depends upon the entity identifiers 142. For example, the security shield deployer 144 creates a new instance of code referenced in the security rule template 132, populates the code with the entity placeholders 134, and then executes the code, e.g., without further modification, to deploy the customized security shield (e.g., by creating a new firewall rule or policy enforced by a network proxy).

Alternatively, generating the customized security shield 102 may in some implementations, include passing an instruction to a language model that requests an executable output. For example, the security rule template 132 includes a natural language instruction that directs a language model to generate code that provides a specific functionality, with reference to the entity placeholders 134. After populating the entity placeholders 134 in the instruction with the corresponding entity identifiers 142, the security shield deployer 144 passes the instruction to the language model and receives an executable code block in response. The security shield deployer 144 either executes this code block directly or transmits this code block to a destination identified within the security policy 126 that, in turn, executes the code block to implement the customized security shield 102.

Per the operations described above, the customized security shield 102 is deployed to enact protections upon physical network locations that collectively comprise the threat surface 150. In various implementations, the customized security shield 102 may assume different forms. For example, the customized security shield 102 may enact a firewall configuration update to block traffic from particular source(s) at a predefined layer of the network. Alternatively, the security shield deployer 144 may define a packet inspection and filtering task that is to be delegated to and enforced by a network proxy.

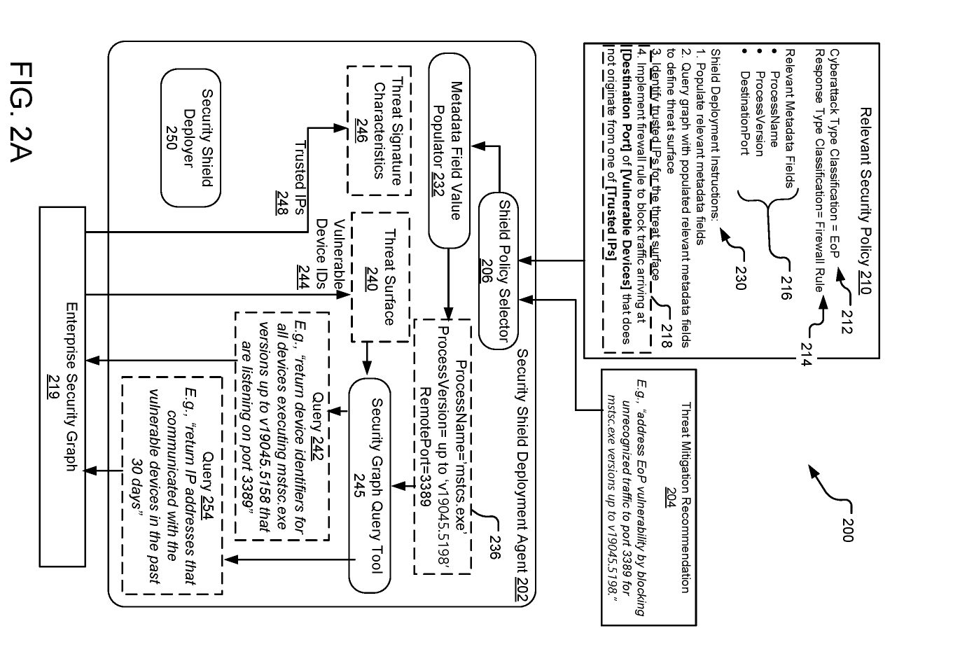

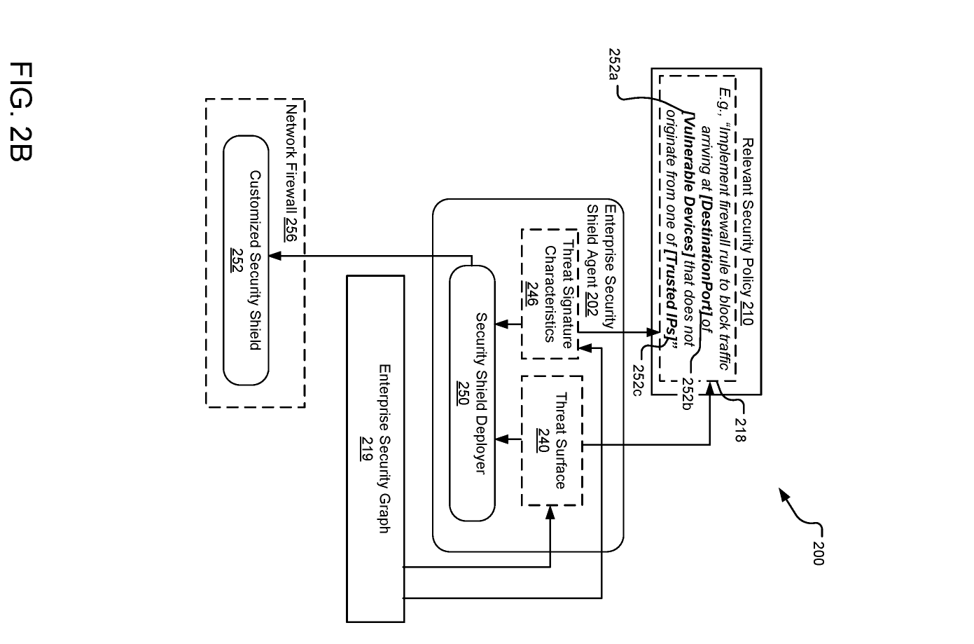

FIG. 2A illustrates aspects of another example system 200 that autonomously develops and deploys customized security shields within a network to proactively thwart cyberattacks designed to exploit newly discovered security vulnerabilities. The system includes a security shield deployment agent 202 that receives, as input, a threat mitigation recommendation 204 describing a recommended security measure to increase network security in view of a newly identified security vulnerability. For example, the newly identified security vulnerability is a software or hardware vulnerability that security teams have not yet had adequate time to patch. In one implementation, the threat mitigation recommendation 204 is generated by a security intelligence model with characteristics the same or similar to those described with respect to FIG. 1.

In the example shown, the threat mitigation recommendation 204 recommends updating a firewall configuration to block unrecognized traffic directed to a particular port ID on network devices configured to run a particular executable file and version number. In this example, threat mitigation recommendation 204 reads: “Address EoP vulnerability by blocking unrecognized traffic to port 3389 for mstsc.exe versions up to v.19045.5198.”. In this example, the threat mitigation recommendation 204 includes language identifying a specific type of cyberattack that is likely to exploit a corresponding identified vulnerability – e.g., an EoP (Elevation of Privilege) attack.

Upon receipt at the security shield deployment agent 202, the threat mitigation recommendation 204 is processed by a security policy selector 208 to determine a cyberattack type classification 212 that pertains to the attack type (e.g., EoP) referenced in the threat mitigation recommendation 204 and/or a response type classification 214 (e.g., firewall configuration update) that pertains to the action described within the threat mitigation recommendation 204. Based on the determined relevant values for the cyberattack type classification 212 and/or the response type classification 214, the security policy selector 206 identifies and selects a relevant security policy 210 from a plurality of predefined and stored security policies (not shown) that are each stored in association with different relevant cyberattack type classification, action classification types, or different combinations of cyberattack type classifications and response type classifications. In some implementations, retrieval of the relevant security policy 210 is based on a single classifier identified as relevant to the cyberattack type classification 212 or response type classification 214. In other implementations, retrieval of the relevant security policy 210 is based on relevant classifiers identified for both cyberattack type classification 212 and the response type classification 214.

The relevant security policy 210 identifies a set of relevant metadata fields 216 that correspond to metadata fields defined within an enterprise security graph 219 in association with entities of the enterprise (e.g., resources or identities) and/or in association with specific communications between the entities. Additionally, the relevant security policy 210 includes shield deployment instructions 230 executable to populate a security rule template 218 deployable to implement the threat mitigation recommendation 204 within the specific physical architecture of the enterprise network described by the enterprise security graph 219.

For simplicity of example, the shield deployment instructions 230 are shown in a generalized and human-readable format, as example steps numbered 1-4. However, in actual implementations, the shield deployment instructions 230 may include code that is executed by the security shield deployment agent 202 or natural language instructions that are passed to a language model to generate code.

A first step (Step 1) in the shield deployment instructions 230 provides for populating the relevant metadata fields 216 with values obtained from the threat mitigation recommendation 204 and/or enterprise security graph 222. This step is performed by a metadata field value populator 232. In the example shown, the relevant metadata fields 216 include “ProcessName,” “ProcessVersion,” and “DestinationPort.”

Although not shown in FIG. 2, it is assumed that the relevant security policy 210 includes some information indicating how each of the relevant metadata fields 216 is to be populated (e.g., from information obtained from the threat mitigation recommendation 204 or from the enterprise security graph 222). For example, the relevant security policy 210 identifies the threat mitigation recommendation 204 as the data source that is to be used to populate the metadata fields “ProcessName,” “ProcessVersion,” “DestinationPort.”

The metadata field value populator 232 includes a named entity recognition (NER) model that processes the threat mitigation recommendation to identified values corresponding to the metadata field names “ProcessName,” “ProcessVersion,” “DestinationPort.” Based on this analysis, the metadata field value populator 232 sets “ProcessName” to equal “mstsc.exe” (the vulnerable executable), “ProcessVersion” to equal “up to v.19045.5198,” and “DestinationPort” to equal “3389,” as generally shown by outputs 236.

The next step (e.g., Step 2) in the shield deployment instructions 230 provides for querying the enterprise security graph 219 based on one or more of the relevant metadata fields 216 and corresponding identified relevant value(s) to identify a set of entities defined within the enterprise security graph 219 that collectively represent a threat surface 240 for the type of attack referenced in the threat mitigation recommendation 204. The threat surface 240 represents and refers to the collective body of resources (e.g., devices, accounts, containers, services) that serve as potential points of attack for a potential cyberattack exploiting the security vulnerability that the threat mitigation recommendation 204 is designed to prevent. In the example of FIG. 2, the threat surface 240 identifies specific devices that are executing up to version 19045.5198 of ‘mstsc.exe,’ with the executable ‘mstsc.exe’ configured to listen for traffic on port 3389.

In implementations, the relevant security policy 210 defines, or at least partially defines, one or more queries to the enterprise security graph 219 executable to retrieve identifiers for entities that collectively comprise the threat surface 240. For example, the relevant security policy 210 includes a query template (not shown) that is to be populated with the relevant metadata values obtained for the relevant metadata fields 216 to define a first query 242 to the enterprise security graph 219. The first query 242 requests the return of identifiers corresponding to all network devices characterized by the relevant metadata values obtained for the relevant metadata fields 216. For the example shown, the first query 242 requests identifiers for all network devices with an installed version “ProcessName=mstsc.exe” that is of “ProcessVersion<= 19045.5198” and configured to listen on “DestinationPort=3389.”

A security graph query tool 245 executes the first query 242 on the enterprise security graph 129 to retrieve a list of entity identifiers (shown as “Vulnerable Device IDs 244”) that are, in turn, stored as “threat surface 240.” In addition to defining the threat surface 240, the security shield deployment agent 202 may, in some implementations, execute additional steps that provide for identifying and storing threat signature characteristics 246 – meaning, characteristic(s) usable to identify incoming communications that are to be subjected to an enforcement action defined by the security rule template 218. Examples of threat signature characteristics 246 include characteristics of a data payload (e.g., a data packet pattern known to be malicious), as well as header information that is used to determine whether a data packet is to be subjected to the corresponding enforcement action. Example header information includes source IP address information (e.g., classes of IPs to be regarded as “trusted” and therefore exempt from the enforcement action), destination IP address information (e.g., IP addresses corresponding to the devices that make up the threat surface 240), as well as other packet header information including without limitation protocol information, packet length information, flags and quality-of-service (QoS) information.

In the example shown where the threat mitigation recommendation 204 defines an action to block all traffic from untrusted sources directed to port ‘3389’, the threat signature characteristics 246 store a destination port of ‘3389” and a source IP address classifier of “unrecognized” – meaning, the enforcement action is to be performed on data packets with the destination port of ‘3389’ that are in route to any IP except for those defined in an array “TrustedIPs” inclusive of known communicators with the threat surface 240. In other implementations, the shield deployment instructions 230 may provide for defining other of the threat signature characteristics 246. It is assumed that the threat signature characteristics 246 are, like the threat surface 240, identified and stored during execution of the shield deployment instructions 230 – e.g., based on metadata values identified for the relevant metadata fields 216 and/or values obtained from the security graph 122 that depend upon one or more of the metadata values.

In the example shown, the shield deployment instructions 230 define, or at least partially define (e.g., include a template for constructing), a second query 254 executable on the enterprise security graph 219 to carry out Step 3 – e.g., a query executable to obtain “trusted IPs 248” for a set of devices that make up the threat surface 240. In this example, executing the second query 254 on the enterprise security graph 219 returns an array of IP addresses corresponding to sources that have communicated with the threat surface 240 (e.g., the vulnerable device IDs 244) in the past 30 days.

Following the above, the security shield deployment agent 202 executes a final step in the executable instructions (Step 4), which provides for populating placeholders (e.g., placeholders “Destination Port,” “Vulnerable Devices,” and “Trusted IPs”) within the security rule template 218 and deploying the result as a customized security shield. In various implementations, the placeholders in the security rule template 218 may correspond to values stored as part of the threat surface 240 or within the threat signature characteristics 246. These values correspond to nodes in the enterprise security graph and/or metadata field values descriptive of nodes or communications between nodes, all of which may be unique for different enterprises and different instances of the enterprise security graph 219 used to implement the same threat mitigation recommendation.

Typically, the placeholders in the security rule template 218 include at least one placeholder corresponding to the set of entity identifiers that collectively make up the threat surface 240 (e.g., the vulnerable device IDS 244 returned in the first query 242). Additionally, the security rule template 218 may include placeholders corresponding to the obtained value(s) for the relevant metadata fields 216 (e.g., the Destination Port) and/or relevant parameters defined among the threat signature characteristics 246 – e.g., the array of “TrustedIPs” corresponding to source addresses of communications that are to be exempted from the blocking action ultimately enforced by the customized security shield.

FIG. 2B illustrates further example operations performed within the system 200 to deploy a customized security shield 252 that implements the threat mitigation recommendation described and shown with respect to FIG. 2A. Prior to the operations shown in FIG. 2B, the threat surface 240 is defined as comprising entity identifiers obtained from the enterprise security graph 219 as generally described with respect to FIG. 2A. Likewise, the threat signature characteristics 246 are identified and defined based on information included in the threat mitigation recommendation 204 (shown in FIG. 2A) or based on quer(ies) to the enterprise security graph 219 that are formulated using at least some of the information included in the threat mitigation recommendation 204.

The security shield deployer 250 then populates placeholders (e.g., placeholders 252a, 252b, 252c) in the security rule template 218 with corresponding applicable values that have been defined as comprising the threat surface 240 or the threat signature characteristics 246.

In the example shown, the placeholder 252a is populated with the destination port ID (‘3389’) initially extracted from the threat mitigation recommendation; the placeholder 252b is populated with an array of entity identifiers collectively stored as the threat surface 240, and the placeholder 252c is populated with an array of trusted IP that are identified, within the threat signature characteristics 246, as exempt from enforcement of the security action enforced by the customized security shield 252. Following the population of the security rule template 218, the security shield deployer 250 then deploys customized security shield 252 to enforce the security rule defined within the security rule template 218 per the parameters defined by the (now populated) placeholders 252a, 252b, and 252c.

In the example shown, the customized security shield 252 is deployed by executing a script that reconfigures a network firewall 256 to block all inbound traffic directed to port 3389 on any of the specific devices of the threat surface 240 (e.g., the devices that have a vulnerable version of mstsc.exe installed), except for traffic that originates at one of the trusted IPs defined within the threat signature characteristics 246. In other implementations, the customized security shield 252 is deployed in other ways, such as by creating a packet inspection rule that is enforced by a network proxy. For example, the packet inspection rule may provide for filtering data packets that contain a particular pattern and that are directed to the threat surface.

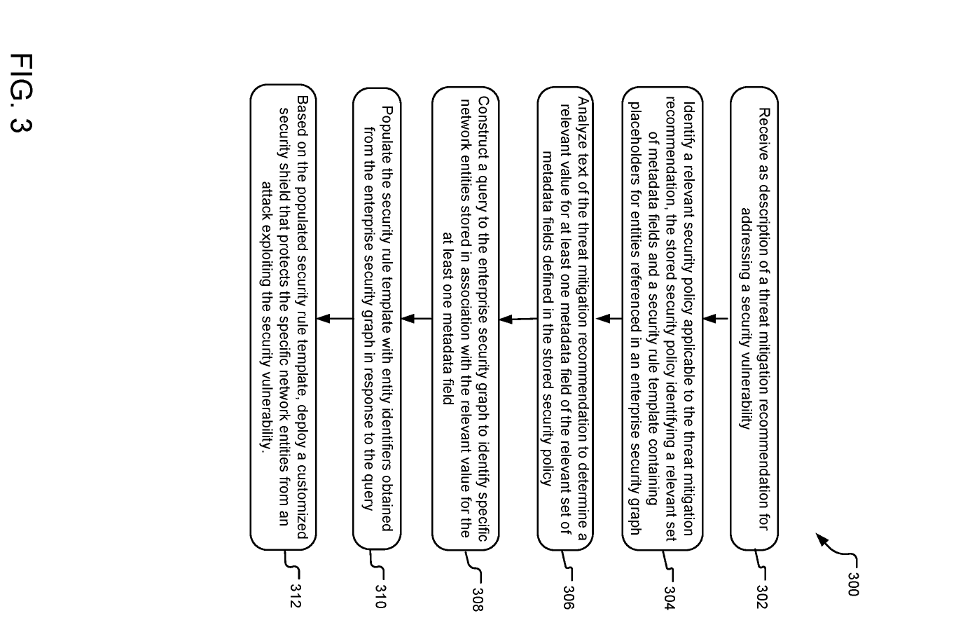

FIG. 3 illustrates example operations 300 for autonomously generating and deploying a customized security shield that temporarily patches a known security vulnerability. The operations 300 commence when a receiving operation 302 receives a description of a threat mitigation recommendation for addressing a security vulnerability. In implementations, the threat mitigation recommendation is generated by a trained security model as generally described with respect to FIG. 1.

A security policy selection operation 304 identifies and selects a relevant security policy applicable to the threat mitigation recommendation. In one implementation, selecting the relevant security policy includes identifying a type of cyberattack (e.g., RCE, EoP, DoS) that may be leveraged to exploit the security vulnerability and/or identifying a classification of security action identified within the threat mitigation recommendation (e.g., a blocking action, filtering rule). The relevant security policy identifies the cyberattack type and/or the security action type and is selected from a plurality of stored policies that identify different types of cyberattacks and/or security actions. The relevant security policy identifies a relevant set of metadata fields and a security rule template that contains placeholders for entities referenced within an enterprise security graph.

A query operation 308 constructs and executes a query on an enterprise security graph. The query requests the return of identifiers corresponding to specific network entities that are stored in the enterprise security graph in association with the relevant value for the at least one metadata field. A template populate operation 310 populates the security rule template with the identifiers obtained in the query operation 308.

A shield deployment operation 312 deploys a customized security shield based on the populated security rule template – e.g., by executing code within the populated security rule template or by providing portions of the populated security rule template to a language model that is trained to generate executable code that is, in turn, executed. The customized security shield protects the specific network entities from an attack exploiting the security vulnerability.

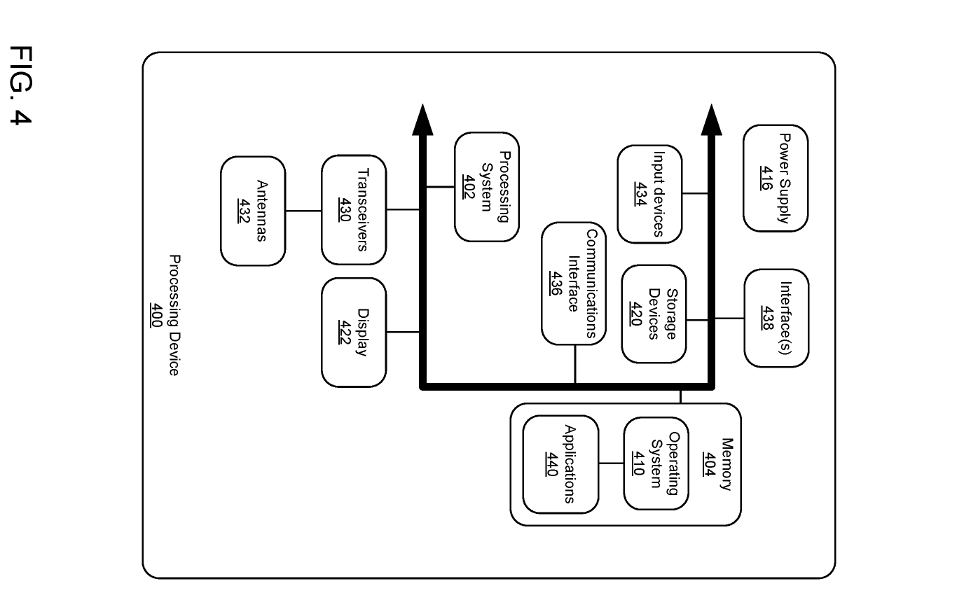

FIG. 4 illustrates an example computing device 400 for use in implementing the described technology. The computing device 400 may be a client computing device (such as a laptop computer, a desktop computer, or a tablet computer), a server/cloud computing device, an Internet-of-Things (IoT), any other type of computing device, or a combination of these options. The computing device 400 includes a processing system 402 and a memory 404. The memory 404 generally includes both volatile memory (e.g., RAM) and nonvolatile memory (e.g., flash memory), although one or the other type of memory may be omitted. An operating system 410 resides in the memory 404 and is executed by the processing system 402. In some implementations, the computing device 400 includes and/or is communicatively coupled to storage 420.

In the example computing device 470, as shown in FIG. 4, one or more software modules, segments, and/or processors, such as applications 450 (e.g., the security intelligence model 118 or the security shield deployment agent 120 of FIG. 1) are loaded into the memory 404 by the operating system 410 and executed by the processor(s) 472. The storage 420 may store an enterprise security graph (e.g., the enterprise security graph 122 of FIG. 1) and/or security policies (e.g., the security policies 124 of FIG. 1).

The computing device 400 may include one or more communication transceivers 430, which may be connected to one or more antenna(s) 432 to provide network connectivity (e.g., mobile phone network, Wi-Fi®, Bluetooth®) to one or more other servers, client devices, IoT devices, and other computing and communications devices. The computing device 400 may further include a communications interface 436 (such as a network adapter or an I/O port, which are types of communication devices) that is used to establish connections over a wide-area network (WAN) or local-area network (LAN). It should be appreciated that the network connections shown are exemplary and that other communications devices and means for establishing a communications link between the computing device 400 and other devices may be used.

The computing device 400 may include one or more input devices 434 such that a user may enter commands and information (e.g., a keyboard, trackpad, or mouse). These and other input devices may be coupled to the server by one or more interfaces 438, such as a serial port interface, parallel port, or universal serial bus (USB). The computing device 400 may further include a display 422, such as a touchscreen display.

The computing device 400 may include a variety of tangible processor-readable storage media and intangible processor-readable communication signals. Tangible processor-readable storage can be embodied by any available media that can be accessed by the computing device 400 and can include both volatile and nonvolatile storage media and removable and non-removable storage media. Tangible processor-readable storage media excludes intangible, transitory communications signals (such as signals per se) and includes volatile and nonvolatile, removable, and non-removable storage media implemented in any method, process, or technology for storage of information such as processor-readable instructions, data structures, program modules, or other data. Tangible processor-readable storage media includes but is not limited to RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 400. In contrast to tangible processor-readable storage media, intangible processor-readable communication signals may embody processor-readable instructions, data structures, program modules, or other data resident in a modulated data signal, such as a carrier wave or other signal transport mechanism. The term "modulated data signal" means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

In some aspects, the techniques described herein relate to a system including: a security shield deployment agent stored in memory and executable by a processing system to: receive as input a description of a threat mitigation recommendation to address a security vulnerability; identify a security policy applicable to the threat mitigation recommendation, the security policy identifying a relevant set of metadata fields and a security rule template containing placeholders for entities referenced in an enterprise security graph; analyze text of the threat mitigation recommendation to determine a relevant value for at least one metadata field of the relevant set of metadata fields defined in the security policy; construct a query to the enterprise security graph to identify specific network entities stored in association with the relevant value for the at least one metadata field; populate the security rule template with entity identifiers obtained from the enterprise security graph in response to the query; and based at least in part on population of the security rule template, deploy a customized security shield to protect the specific network entities from an attack exploiting the security vulnerability.

In some aspects, the techniques described herein relate to a system, further including: a security intelligence model trained on a corpus of textual data that includes descriptions of security vulnerabilities paired with threat mitigation actions identified as appropriate responses to the security vulnerabilities, the security intelligence model configured to: receive as input a description of a potential security vulnerability; and based on processing of the description, generate the threat mitigation recommendation.

In some aspects, the techniques described herein relate to a system, wherein deploying the customized security shield includes updating a firewall configuration to block traffic in route to the specific network entities.

In some aspects, the techniques described herein relate to a system, wherein deploying the customized security shield includes configuring a network proxy to enforce a packet inspection or filtering action.

In some aspects, the techniques described herein relate to a system, wherein the security shield deployment agent is further configured to: determine the relevant value for the at least one metadata field by instructing a named entity recognition (NER) model to identify entities named within the description of the threat mitigation recommendation that correspond to the at least one metadata field identified in the security policy.

In some aspects, the techniques described herein relate to a system, wherein the security policy includes instructions for constructing the query to the enterprise security graph, and wherein the query references both the at least one metadata field and the relevant value for the at least one metadata field.

In some aspects, the techniques described herein relate to a system, wherein the threat mitigation recommendation identifies a characteristic of a cyberattack designed to exploit the security vulnerability, and wherein deployment of the customized security shield creates a security rule that selectively blocks incoming communications that include the characteristic.

In some aspects, the techniques described herein relate to a system, wherein the security shield deployment agent identifies the security policy applicable to the threat mitigation recommendation by actions that include: identifying a select attack type associated with the security vulnerability, wherein the security policy is associated with the select attack type and is selected from a plurality of different policies associated with different attack types.

In some aspects, the techniques described herein relate to a system, wherein the relevant set of metadata fields defined within the security policy include metadata fields that identify a process and process version installed on devices impacted by the security vulnerability, and wherein the security shield deployment agent analyzes the text of the threat mitigation recommendation to determine values for the process and process version.

In some aspects, the techniques described herein relate to a system, wherein the specific network entities are specific devices impacted by the security vulnerability, wherein the security policy includes an instruction to query the enterprise security graph to identify a set of internet protocol (IP) addresses that have previously communicated with the specific devices, and wherein the customized security shield enforces a filtering or blocking rule that define an exception for communications received from the set of IP addresses.

In some aspects, the techniques described herein relate to a method including: receiving as input a description of a threat mitigation recommendation for addressing a security vulnerability; identifying a security policy applicable to the threat mitigation recommendation, the security policy identifying a relevant set of metadata fields and a security rule template containing placeholders for entities referenced in an enterprise security graph; analyzing text of the threat mitigation recommendation to determine a relevant value for at least one metadata field of the relevant set of metadata fields defined in the security policy; constructing a query to the enterprise security graph to identify specific network entities stored in association with the relevant value for the at least one metadata field; populating the security rule template with entity identifiers obtained from the enterprise security graph in response to the query; and based at least in part on population of the security rule template, deploying a customized security shield to protect the specific network entities from an attack exploiting the security vulnerability.

In some aspects, the techniques described herein relate to a method, wherein identifying the security policy includes identifying a select attack type associated with the security vulnerability and selecting the security policy from a plurality of different policies associated with different attack types, the security policy identifying the select attack type.

In some aspects, the techniques described herein relate to a method, further including: providing a description of the security vulnerability as input to a security intelligence model trained on a corpus of textual data, the corpus including descriptions of security vulnerabilities paired with threat mitigation actions identified as appropriate responses to the security vulnerabilities; and receiving as output from the security intelligence model the threat mitigation recommendation.

In some aspects, the techniques described herein relate to a method, wherein deploying the customized security shield includes updating a firewall configuration or configuring a network proxy to enforce a filtering action.

In some aspects, the techniques described herein relate to a method, wherein analyzing text of the threat mitigation recommendation to determine the relevant value for the at least one metadata field further including: instructing a named entity recognition (NER) model to identify entities named within the description of the threat mitigation recommendation that corresponds to the at least one metadata field identified in the security policy.

In some aspects, the techniques described herein relate to a method, wherein the security policy includes instructions for constructing the query to the enterprise security graph, and wherein the query references both the at least one metadata field and the relevant value for the at least one metadata field.

In some aspects, the techniques described herein relate to a method, wherein the threat mitigation recommendation identifies a characteristic of a cyberattack designed to exploit the security vulnerability, and wherein deployment of the customized security shield creates a security rule that selectively blocks or redirects incoming communications that include the characteristic.

In some aspects, the techniques described herein relate to one or more tangible processor-readable storage media encoding processor-executable instructions for executing a computer process including: receiving, at a security intelligence model, a description of a security vulnerability, the security intelligence model trained on a corpus of textual data that includes descriptions of security vulnerabilities paired with threat mitigation actions identified as appropriate responses to the security vulnerabilities; generating, by the security intelligence model, a threat mitigation recommendation based on the description of the security vulnerability; based on an action type or cyberattack type identified within the threat mitigation recommendation, select a security policy applicable to the threat mitigation recommendation, the security policy identifying a relevant set of metadata fields; analyzing text of the threat mitigation recommendation to determine a relevant value for at least one metadata field of the relevant set of metadata fields defined in the security policy; constructing a first query to an enterprise security graph to identify specific network entities stored in association with the relevant value for the at least one metadata field; defining a threat surface that includes the specific network entities; and deploying a security rule or policy that protects the threat surface from an attack exploiting the security vulnerability.

In some aspects, the techniques described herein relate to one or more tangible processor-readable storage media, further including: constructing a second query that references the relevant value for the at least one metadata field and that requests an associated set of values from the enterprise security graph; and populating threat signature characteristics with the associated set of values returned from the enterprise security graph, wherein the security rule or policy is enforced to block communications described by the threat signature characteristics.

In some aspects, the techniques described herein relate to one or more tangible processor-readable storage media, wherein the first query references both the at least one metadata field and the relevant value for the at least one metadata field.

The logical operations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of example implementations.

What is claimed is:

1. A system comprising:
a security shield deployment agent stored in memory and executable by a processing system to:
receive as input a description of a threat mitigation recommendation to address a security vulnerability;
identify a security policy applicable to the threat mitigation recommendation, the security policy identifying a set of metadata fields and a security rule template containing placeholders for entities referenced in an enterprise security graph;
analyze text of the threat mitigation recommendation to determine a value for at least one metadata field of the set of metadata fields defined in the security policy;
construct a query to the enterprise security graph to determine an entity identifier corresponding to an entity or resource of a specific network, the entity identifier stored in the enterprise security graph in association with the value for the at least one metadata field;
populate the security rule template with the entity identifier obtained from the enterprise security graph in response to the query; and
based at least in part on population of the security rule template, deploy a customized security shield to protect a network device or resource identified by the entity identifier from an attack exploiting the security vulnerability.

2. The system of claim 1, further comprising:
a security intelligence model trained on a corpus of textual data that includes descriptions of security vulnerabilities paired with threat mitigation actions identified as appropriate responses to the security vulnerabilities, the security intelligence model configured to:
receive as input a description of a potential security vulnerability; and
based on processing of the description, generate the threat mitigation recommendation.

3. The system of claim 1, wherein deploying the customized security shield includes updating a firewall configuration to block traffic in route to the network device or resource.

4. The system of claim 1, wherein deploying the customized security shield includes configuring a network proxy to enforce a packet inspection or filtering action.

5. The system of claim 1, wherein the security shield deployment agent is further configured to:
determine the value for the at least one metadata field by instructing a named entity recognition (NER) model to identify entities named within the description of the threat mitigation recommendation that correspond to the at least one metadata field identified in the security policy.

6. The system of claim 1, wherein the security policy includes instructions for constructing the query to the enterprise security graph, and wherein the query references both the at least one metadata field and the value for the at least one metadata field.

7. The system of claim 1, wherein the threat mitigation recommendation identifies a characteristic of a cyberattack designed to exploit the security vulnerability, and wherein deployment of the customized security shield creates a security rule that selectively blocks incoming communications that include the characteristic.

8. The system of claim 1, wherein the security shield deployment agent identifies the security policy applicable to the threat mitigation recommendation by actions that include:
identifying a cyberattack type classification associated with the security vulnerability, wherein the security policy is associated with the cyberattack type classification and is selected from a plurality of different policies associated with different cyberattack types.

9. The system of claim 1, wherein the set of metadata fields defined within the security policy include metadata fields that identify a process and process version installed on devices impacted by the security vulnerability, and wherein the security shield deployment agent analyzes the text of the threat mitigation recommendation to determine values for the process and process version.

10. The system of claim 1, wherein the network device or resource is a specific device impacted by the security vulnerability,
wherein the security policy includes an instruction to query the enterprise security graph to identify a set of internet protocol (IP) addresses that have previously communicated with the specific device,
and wherein the customized security shield enforces a filtering or blocking rule that define an exception for communications received from the set of IP addresses.

11. A method comprising:
receiving as input a description of a threat mitigation recommendation for addressing a security vulnerability;
identifying a security policy applicable to the threat mitigation recommendation, the security policy identifying a set of metadata fields and a security rule template containing placeholders for entities referenced in an enterprise security graph;
analyzing text of the threat mitigation recommendation to determine values for the set of metadata fields defined in the security policy;
constructing one or more queries to the enterprise security graph that reference the values for the set of metadata fields to obtain, in response to the one or more queries, a set of entity identifiers corresponding to entities or resources of a specific network, the set of entity identifiers stored in the enterprise security graph in association with the values for the set of metadata fields;
populating the security rule template with the set of entity identifiers obtained from the enterprise security graph in response to the one or more queries;
deploying a customized security shield by executing code included in the security rule template, the code refencing the set of entity identifiers obtained from the enterprise security graph, wherein the customized security shield is a security rule or policy that protects specific devices identified by the set of entity identifiers from an attack exploiting the security vulnerability.

12. The method of claim 11, wherein identifying the security policy includes identifying a cyberattack type classification associated with the security vulnerability and selecting the security policy from a plurality of different policies associated with different cyberattack type classifications, the security policy identifying the cyberattack type classification.

13. The method of claim 11, further comprising:
providing a description of the security vulnerability as input to a security intelligence model trained on a corpus of textual data, the corpus including descriptions of security vulnerabilities paired with threat mitigation actions identified as appropriate responses to the security vulnerabilities; and
receiving as output from the security intelligence model the threat mitigation recommendation.

14. The method of claim 11, wherein deploying the customized security shield includes updating a firewall configuration or configuring a network proxy to enforce a filtering action.

15. The method of claim 11, wherein analyzing text of the threat mitigation recommendation to determine the values for the set of metadata fields further comprising:
instructing a named entity recognition (NER) model to identify entities named within the description of the threat mitigation recommendation that corresponds to the set of metadata fields identified in the security policy.

16. The method of claim 11, wherein the security policy includes instructions for constructing the one or more queries to the enterprise security graph, and wherein the one or more queries reference both the set of metadata fields and the values for the set of metadata fields.

17. The method of claim 16, wherein the threat mitigation recommendation identifies a characteristic of a cyberattack designed to exploit the security vulnerability, and wherein deployment of the customized security shield creates a security rule that selectively blocks or redirects incoming communications that include the characteristic.

18. One or more tangible processor-readable storage media encoding processor-executable instructions for executing a computer process comprising:
receiving, at a security intelligence model, a description of a security vulnerability, the security intelligence model trained on a corpus of textual data that includes descriptions of security vulnerabilities paired with threat mitigation actions identified as appropriate responses to the security vulnerabilities;
generating, by the security intelligence model, a threat mitigation recommendation based on the description of the security vulnerability;
based on an action type or cyberattack type identified within the threat mitigation recommendation, select a security policy applicable to the threat mitigation recommendation, the security policy identifying a set of metadata fields;
analyzing text of the threat mitigation recommendation to determine a value for at least one metadata field of the set of metadata fields defined in the security policy;
constructing a first query to an enterprise security graph to determine an entity identifier corresponding to an entity or resource of a specific network, the entity identifier stored in the enterprise security graph in association with the value for the at least one metadata field;
defining a threat surface that includes the entity identifier; and
deploying a security rule or policy that protects the threat surface from an attack exploiting the security vulnerability.

19. The one or more tangible processor-readable storage media of claim 18, further comprising:
constructing a second query that references the value for the at least one metadata field and that requests an associated set of values from the enterprise security graph; and
populating threat signature characteristics with the associated set of values returned from the enterprise security graph, wherein the security rule or policy is enforced to block communications described by the threat signature characteristics.

20. The one or more tangible processor-readable storage media of claim 18, wherein the first query references both the at least one metadata field and the value for the at least one metadata field.
